(19) United States
(12) Patent Application Publication
(10) Pub. No.: US 2019/0377470 A1
(43) Pub. Date: Dec. 12, 2019

(54) TOUCH SENSING DEVICE AND METHOD FOR SENSING TOUCH SENSING SIGNAL

(71) Applicant: Shang-Li LEE, Keelung City (TW)

(72) Inventor: Shang-Li LEE, Keelung City (TW)

(21) Appl. No.: 16/429,330

(22) Filed: Jun. 3, 2019

(30) Foreign Application Priority Data
Jun. 7, 2018 (TW) 107119726

(51) Int. Cl. G06F 3/041; G06F 3/044

(52) U.S. Cl. CPC G06F 3/04164; G06F 3/044

(57) ABSTRACT

A method for sensing a touch sensing signal is provided and is applicable to a touch sensing device. During touch sensing, any sensing electrode is precharged by using a direct current until a level of the sensing electrode is stable. Then, a scanning operation is performed on a sensing point formed by the stabilized sensing electrode and multiple driving electrodes, to reduce a settling time.

### CROSS-REFERENCE TO RELATED APPLICATION

This non-provisional application claims priority under 35 U.S.C. § 119(a) to Patent Application No. 107119726 in Taiwan, R.O.C. on Jun. 7, 2018, the entire contents of which are hereby incorporated by reference.

### BACKGROUND

### Technical Field

The present invention relates to a touch sensing device and a method for sensing a touch sensing signal.

### Related Art

Generally, a touch sensing device includes a plurality of sensing electrodes and a plurality of driving electrodes. The touch sensing device scans the sensing electrodes and the driving electrodes, and reads a touch sensing signal by using the sensing electrodes. A common scanning manner is to provide a specific function voltage (for example, a square wave, a sinusoidal wave, or a pulse) for any driving electrode, and then sequentially charge and discharge the sensing electrodes, to separately measure capacitance values (equivalent to the touch sensing signal) of the sensing electrodes and corresponding to the driving electrodes. When a voltage is added at a location on a circuit at first, a settling process is required. Such a case occurs when jumping is required due to controlling at a driving and sensing location in an array sensing mechanism. A driving signal can drive the driving electrodes to an acceptable stable state only after a period of settling time, and a reliable read value can be obtained only by performing reading on the sensing electrodes in this case. The settling time usually needs a period of time up to dozens of milliseconds when either the driving electrodes or the sensing electrodes change.

### SUMMARY

However, a time for scanning a sensing electrode and a driving electrode affects efficiency of a touch sensing device in reading a touch sensing signal. Therefore, a touch sensing device and a method for sensing a touch sensing signal are required, to efficiently read a touch sensing signal and improve touch control effectiveness and performance of the touch sensing device.

In view of the foregoing problem, the present invention provides a touch sensing device and a method for sensing a touch sensing signal, to reduce a settling time, that is, shorten an entire driving and reading period, to effectively increase a frame rate and further improve the touch control effectiveness and performance of the touch sensing device.

In an embodiment, a method for sensing a touch sensing signal includes: providing a direct current voltage for a first sensing electrode in a first time period, to stabilize the first sensing electrode; performing a first scanning operation by using the stabilized first sensing electrode in a second time period; providing the direct current voltage for a second sensing electrode in a third time period, to stabilize the second sensing electrode, where the third time period is after the second time period; and performing a second scanning operation by using the stabilized second sensing electrode in a fourth time period. The second time period is after the first time period, the third time period is after the second time period, and the fourth time period is after the third time period.

The execution step of the first scanning operation includes the following steps: driving a first driving electrode by using a driving signal within a first operation time in the second time period, and measuring, based on the stabilized first sensing electrode, a capacitance value of the driven first driving electrode and corresponding to the first sensing electrode; and driving a second driving electrode by using the driving signal within a second operation time in the second time period, and measuring, based on the stabilized first sensing electrode, a capacitance value of the driven second driving electrode and corresponding to the first sensing electrode.

The execution step of the second scanning operation includes the following steps: driving the first driving electrode by using the driving signal within a first operation time in the fourth time period, and measuring, based on the stabilized second sensing electrode, a capacitance value of the driven first driving electrode and corresponding to the second sensing electrode; and driving the second driving electrode by using the driving signal within a second operation time in the fourth time period, and measuring, based on the second sensing electrode, a capacitance value of the driven second driving electrode and corresponding to the second sensing electrode.

In another embodiment, a method for sensing a touch sensing signal includes: precharging a charging/discharging unit by using a direct current voltage in a first time period, and charging a first sensing electrode by using the charging/discharging unit, to stabilize the first sensing electrode; performing a first scanning operation by using the stabilized first sensing electrode in a second time period; precharging a charging/discharging unit by using the direct current voltage in a third time period, and charging a second sensing electrode by using the charging/discharging unit, to stabilize the second sensing electrode; and performing a second scanning operation by using the stabilized second sensing electrode in a fourth time period. The second time period is after the first time period, the third time period is after the second time period, and the fourth time period is after the third time period.

The execution step of the first scanning operation includes the following steps: driving a first driving electrode by using a driving signal within a first operation time in the second time period, and measuring, based on the stabilized first sensing electrode, a capacitance value of the driven first driving electrode and corresponding to the first sensing electrode; and driving a second driving electrode by using the driving signal within a second operation time in the second time period, and measuring, based on the stabilized first sensing electrode, a capacitance value of the driven second driving electrode and corresponding to the first sensing electrode.

The execution step of the second scanning operation includes the following steps: driving the first driving electrode by using the driving signal within a first operation time in the fourth time period, and measuring, based on the stabilized second sensing electrode, a capacitance value of the driven first driving electrode and corresponding to the second sensing electrode; and driving the second driving electrode by using the driving signal within a second operation time in the fourth time period, and measuring, based on the second sensing electrode, a capacitance value of the driven second driving electrode and corresponding to the second sensing electrode.

In an embodiment, a touch sensing device includes: a first sensing electrode, a second sensing electrode, a first driving electrode, a second driving electrode, a voltage source, a multiplexing circuit, and a signal processing circuit. The multiplexing circuit is coupled to the first sensing electrode, the second sensing electrode, and the voltage source. The signal processing circuit is coupled to the first sensing electrode, the second sensing electrode, the first driving electrode, the second driving electrode, and the multiplexing circuit. The voltage source is configured to provide a direct current voltage.

Herein, the signal processing circuit is configured to perform the following steps: controlling, in a first time period, the multiplexing circuit to electrically connect to the voltage source and the first sensing electrode, so that the direct current voltage charges the first sensing electrode to stabilize the first sensing electrode; performing a first scanning operation by using the stabilized first sensing electrode in a second time period; controlling, in a third time period, the multiplexing circuit to electrically connect to the voltage source and the second sensing electrode, so that the direct current voltage charges the second sensing electrode to stabilize the second sensing electrode; and performing a second scanning operation by using the stabilized second sensing electrode in a fourth time period. The second time period is after the first time period, the third time period is after the second time period, and the fourth time period is after the third time period.

The execution step of the first scanning operation includes the following steps: driving a first driving electrode by using a driving signal within a first operation time in the second time period, and measuring, based on the stabilized first sensing electrode, a capacitance value of the driven first driving electrode and corresponding to the first sensing electrode; and driving a second driving electrode by using the driving signal within a second operation time in the second time period, and measuring, based on the stabilized first sensing electrode, a capacitance value of the driven second driving electrode and corresponding to the first sensing electrode.

The execution step of the second scanning operation includes the following steps: driving the first driving electrode by using the driving signal within a first operation time in the fourth time period, and measuring, based on the stabilized second sensing electrode, a capacitance value of the driven first driving electrode and corresponding to the second sensing electrode; and driving the second driving electrode by using the driving signal within a second operation time in the fourth time period, and measuring, based on the second sensing electrode, a capacitance value of the driven second driving electrode and corresponding to the second sensing electrode.

In another embodiment, a touch sensing device includes: a first sensing electrode, a second sensing electrode, a first driving electrode, a second driving electrode, a voltage source, a multiplexing circuit, and a signal processing circuit. The multiplexing circuit is coupled to the first sensing electrode, the second sensing electrode, and the voltage source. The signal processing circuit is coupled to the first sensing electrode, the second sensing electrode, the first driving electrode, the second driving electrode, and the multiplexing circuit. The voltage source is configured to provide a direct current voltage.

Herein, the signal processing circuit is configured to perform the following steps: controlling, in a first time period, the multiplexing circuit to tuna on the voltage source to precharge a charging/discharging unit by using the direct current voltage, then controlling the multiplexing circuit to turn off the voltage source, and charging the first sensing electrode by using the voltage source after the precharging, to stabilize the first sensing electrode; performing a first scanning operation by using the stabilized first sensing electrode in a second time period; controlling, in a third time period, the multiplexing circuit to turn on the voltage source to precharge the charging/discharging unit by using the direct current voltage, then controlling the multiplexing circuit to turn off the voltage source, and charging the second sensing electrode by using the voltage source, to stabilize the first sensing electrode; and performing a second scanning operation by using the stabilized second sensing electrode in a fourth time period. The second time period is after the first time period, the third time period is after the second time period, and the fourth time period is after the third time period.

The execution step of the first scanning operation includes the following steps: driving a first driving electrode by using a driving signal within a first operation time in the second time period, and measuring, based on the stabilized first sensing electrode, a capacitance value of the driven first driving electrode and corresponding to the first sensing electrode; and driving a second driving electrode by using the driving signal within a second operation time in the second time period, and measuring, based on the stabilized first sensing electrode, a capacitance value of the driven second driving electrode and corresponding to the first sensing electrode.

The execution step of the second scanning operation includes the following steps: driving the first driving electrode by using the driving signal within a first operation time in the fourth time period, and measuring, based on the stabilized second sensing electrode, a capacitance value of the driven first driving electrode and corresponding to the second sensing electrode; and driving the second driving electrode by using the driving signal within a second operation time in the fourth time period, and measuring, based on the second sensing electrode, a capacitance value of the driven second driving electrode and corresponding to the second sensing electrode.

### BRIEF DESCRIPTION OF THE DRAWINGS

The present invention will become more fully understood from the detailed description given herein below for illustration only, and thus are not limitative of the present invention, and wherein:

FIG. 1 is a schematic diagram of a touch sensing device applied to any embodiment of the present invention;

FIG. 2 is a schematic diagram of an example of a signal sensor in FIG. 1;

FIG. 3 is a schematic circuit diagram of an example of touch sensing of a sensing point of the touch sensing device in FIG. 1;

FIG. 4 is a schematic flowchart of a method for sensing a touch sensing signal according to an embodiment of the present invention;

FIG. 5 is a schematic circuit diagram of an example of touch sensing of a sensing point of the touch sensing device in FIG. 1; and

FIG. 6 is a schematic flowchart of a method for sensing a touch sensing signal according to another embodiment of the present invention.

### DETAILED DESCRIPTION

First, a method for sensing a touch sensing signal according to any embodiment of the present invention is applicable to a touch sensing device, for example, but not limited to, a control panel, an electronic drawing board, or a handwriting tablet. In some embodiments, the touch sensing device and a display may be integrated into a touch screen. In addition, the touch sensing device may be touched by hand or a touch element such as a touch pen or a touch brush.

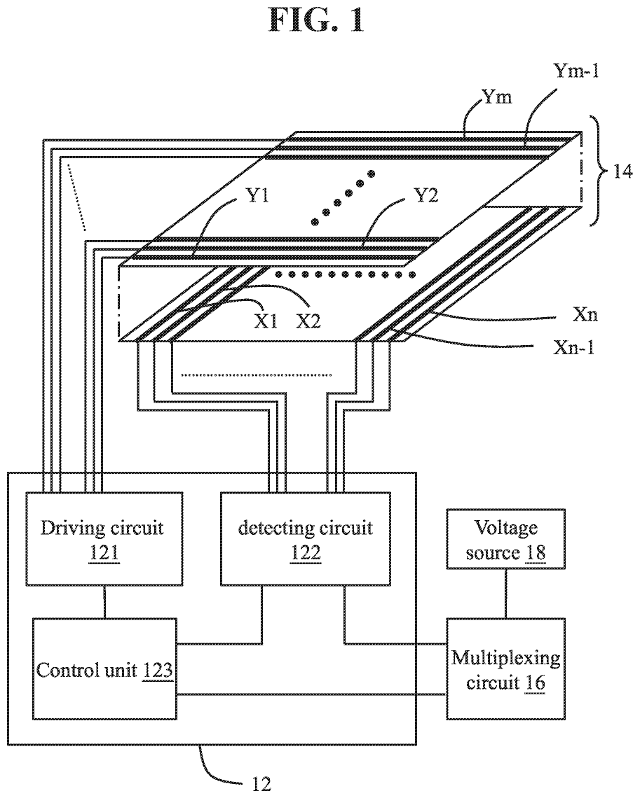

Referring to FIG. 1, the touch sensing device includes a signal processing circuit 12 and a signal sensor 14. The signal sensor 14 is connected to the signal processing circuit 12. The signal sensor 14 includes multiple electrodes (for example, driving electrodes X1 to Xn and sensing electrodes Y1 to Ym) disposed in an interleaved manner. The n and m are positive integers. The n may be or may not be equal to m.

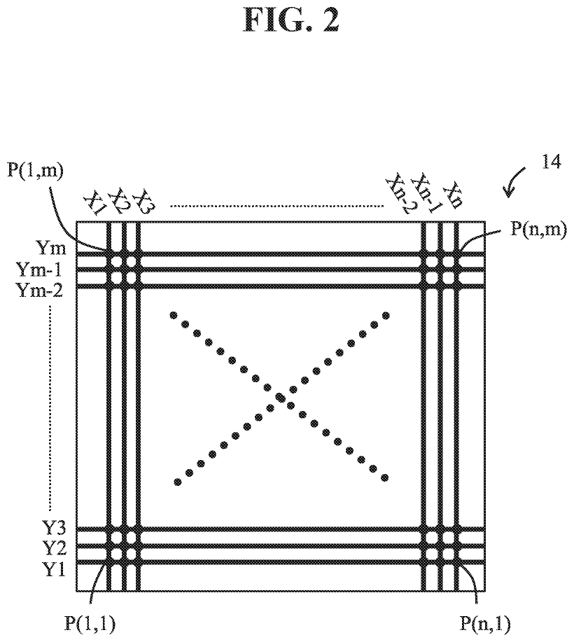

When viewed from a top view, the driving electrodes X1 to Xn and the sensing electrodes Y1 to Ym are interleaved, and a plurality of sensing points P(1, 1) to P(n, m) configured by using a matrix is defined, as shown in FIG. 2. In some embodiments, the driving electrodes X1 to Xn and the sensing electrodes Y1 to Ym may be located on different planes (located on different sensor layers), and there may include, but is not limited to, an insulation layer (not shown) sandwiched between the different planes. In some other embodiments, the driving electrodes X1 to Xn and the sensing electrodes Y1 to Ym may be located on a same plane, that is, located on a single sensor layer only.

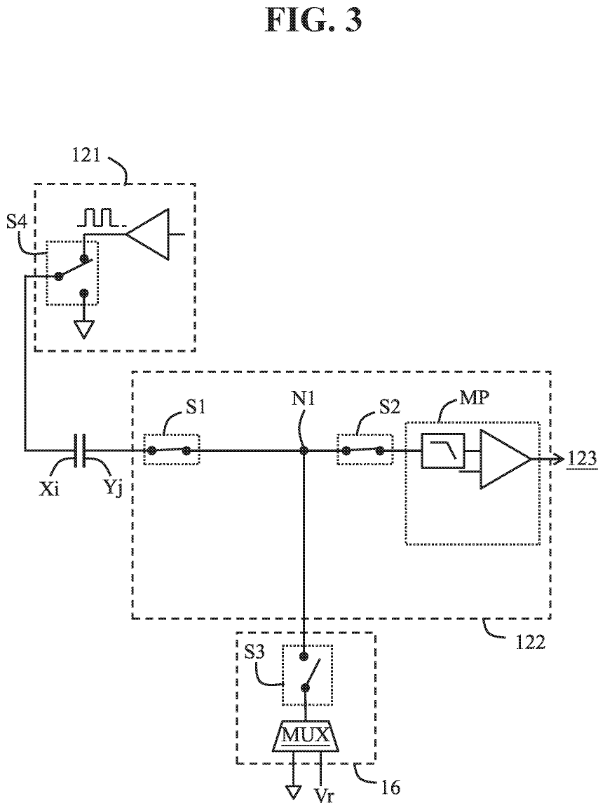

The signal processing circuit 12 includes a driving circuit 121, a detecting circuit 122, and a control unit 123. The control unit 123 is coupled to the driving circuit 121 and the detecting circuit 122. Herein, the driving circuit 121 and the detecting circuit 122 may be integrated to a single element, or may be implemented by using two elements, depending on a current situation within a design time. Referring to FIG. 3, the driving circuit 121 is configured to output a driving signal to a to-be-driven driving electrode Xi (one of X1 to Xn), and the detecting circuit 122 is configured to measure a capacitance value of the driven driving electrode Xi and corresponding to a stabilized sensing electrode Yj (one of Y1 to Ym). i is any one of 1 to n, and j is any one of 1 to m. Herein, the control unit 123 can be configured to: control operation of the driving circuit 121 and the detecting circuit 122, and determine, according to a background signal (a capacitance value when it is determined there is no touch) and a sensing signal (a capacitance value when it is to be determined whether a touch occurs), a change in a capacitance value of each sensing point. In some embodiments, the driving signal has a feature of a continuous function (differentiable). The driving signal may be a voltage change signal, a current change signal, a frequency change signal, or a signal of a combination thereof. In an example, the driving signal may be a periodical wave, or a resistance-capacitance (RC) constant point.

Herein, the touch sensing device can perform the method for sensing a touch sensing signal according to any embodiment of the present invention, to perform touch sensing on sensing points P(1, 1) to P(n, m), so as to reduce a time required by a switch and the sensing points P(1, 1) to P(n, m) to be compatible with each other and/or stable, that is, shorten an entire driving and reading period, to effectively increase a frame rate and further improve touch control effectiveness and performance of the touch sensing device.

Herein, the touch sensing device may further include a multiplexing circuit 16 and a voltage source 18. The multiplexing circuit 16 is coupled between the voltage source 18 and each sensing electrode, and coupled between the ground and each sensing electrode. The control unit 123 is coupled to a control end of the multiplexing circuit 16. In some embodiments, the multiplexing circuit 16 may include a plurality of multiplexers separately corresponding to the sensing electrodes Y1 to Ym. Each multiplexer is coupled between the voltage source 18 and a corresponding sensing electrode, and coupled between the ground and a corresponding sensing electrode.

The voltage source 18 is configured to provide a direct current voltage. In some embodiments, the direct current voltage may be a median of the driving signal. For example, if the driving signal is 3.3 V (volt), the direct current voltage may be 1.65 V.

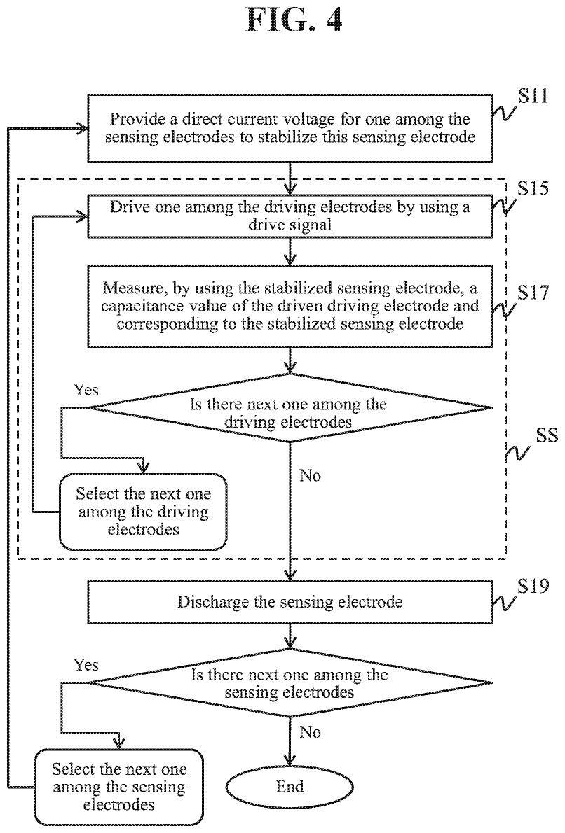

Referring to FIG. 1 to FIG. 4, in some embodiments, during touch sensing, the control unit 123 controls the multiplexing circuit 16, so that the multiplexing circuit 16 electrically connects to the voltage source 18 and the sensing electrode Yj. In this case, the direct current voltage Vr output by the voltage source 18 is provided for the sensing electrode Yj through the multiplexing circuit 16, so that the direct current voltage Vr precharges the sensing electrode Yj to stabilize the sensing electrode Yj (step S11). During precharging of the sensing electrode Yj, other sensing electrodes Y1 to Yj−1 and Yj+1 to Ym are floating (switched to a floating state or a specific voltage). In some embodiments, before the precharging, the multiplexing circuit 16 first electrically connects the sensing electrode Yj to the ground for discharging. After the discharging, the multiplexing circuit 16 then electrically connects the sensing electrode Yj to the voltage source 18, to stabilize the sensing electrode Yj.

For example, in an example of step S11, during touch sensing of sensing points P(j, 1) to P(j, m) on the sensing electrode Yj, a switch S1 in the detecting circuit 122 and coupled to the sensing electrode Yj is on, and a switch S2 in the detecting circuit 122 is off. A switch S3 in the multiplexing circuit 16 and corresponding to the sensing electrode Yj enables a junction N1 and an output terminal of a multiplexer MUX, and the multiplexer MUX enables an output terminal of the multiplexer MUX and is grounded, so that the sensing electrode Yj discharges to the ground. Then the switches S1 and S3 remains on, the switch S2 remains off, and the multiplexer MUX switches to the output terminal of the multiplexer MUX and the direct current voltage Vr, so that the direct current voltage Vr precharges the sensing electrode Yj, until a level of the sensing electrode Yj reaches a stability voltage.

Subsequently, the control unit 123 performs a scanning operation SS by using the stabilized sensing electrode Yj. In other words, after this sensing electrode Yj is stabilized, the control unit 123 controls the driving circuit 121 to drive a first one among driving electrode X1 by using the driving signal (step S15), and after this driving electrode X1 is driven and stabilized, controls the detecting circuit 122 to measure, by using the stabilized sensing electrode Yj, a capacitance value of induced capacitance (that is, a sensing point P(1, j)) generated by the driven driving electrode X1 and the stabilized sensing electrode Yj (step S17). After measuring the capacitance value of the sensing point P(1, j), the control unit 123 controls the driving circuit 121 to drive a next one among driving electrode X2 by using the driving signal (step S15). After this driving electrode X2 is driven and stabilized, the control unit 123 controls the detecting circuit 122 to measure the stabilized sensing electrode Yj, that is, measure, by using the stabilized sensing electrode Yj, a capacitance value of induced capacitance (that is, a sensing point P(2, j)) generated by the driven driving electrode X2 and the stabilized sensing electrode Yj (step S17). The rest can be deduced by analogy, until all the driving electrodes X1 to Xn are driven and capacitance values of all driving electrodes and corresponding to the sensing electrode Yj are measured. In this case, the control unit 123 can obtain the capacitance values of the n sensing points P(1, j) to P(n, j).

Then, the control unit 123 controls the detecting circuit 122 to cause the measured sensing electrode Yj to discharge (step S19). In this case, other sensing electrodes Y1 to Yj−1 and Yj+1 to Ym are in the floating state (for example, the corresponding switch S1 is off).

After the sensing electrode Yj discharges, touch sensing is further performed on sensing points P(j+1, 1) to P(j+1, m) on the sensing electrode Yj+1. That is, steps S11 to S19 are repeatedly performed by using the sensing electrode Yj+1, to obtain capacitance values of induced capacitance generated by all driving electrodes and the sensing electrode Yj+1, that is, obtain the capacitance values of the n sensing points P(1, j+1) to P(n, j+1).

In this way, precharging of the sensing electrode for stabilization and the scanning operation SS based on the stabilized sensing electrode are repeatedly performed, until all the sensing electrodes are stabilized and measured, so as to obtain the capacitance values (an array signal) of all the sensing points P(1, 1) to P(n, m).

For example, under control of the control unit 123, in the first time period, the voltage source 18 provides the direct current voltage Vr for a first one among sensing electrode Y1 (hereinafter referred to as a first sensing electrode Y1) through the multiplexing circuit 16, so as to use the direct current voltage Vr to precharge the first sensing electrode Y1 to a stable state. In this case, other sensing electrodes Y2 to Ym are in the floating state.

In the second time period, the control unit 123 performs a scanning operation (hereinafter referred to as a first scanning operation) based on the first sensing electrode Y1 with the stability voltage. Herein, the second time period is after the first time period. In an example, the second time period is subsequent to the first time period.

Still further, during performing of the first scanning operation in the second time period, that is, within a first operation time in the second time period, the driving circuit 121 transmits the driving signal to the first one among driving electrode X1 (hereinafter referred to as a first driving electrode X1), and the detecting circuit 122 reads, by using the first sensing electrode Y1, the capacitance value of the first driving electrode X1 and corresponding to the first sensing electrode Y1. Herein, after the driving signal starts to be provided for the first driving electrode X1, the detecting circuit 122 waits for a period of stability time, and then performs measurement. In some embodiments, during driving of the first driving electrode X1, the driving circuit 121 does not drive other driving electrodes X2 to Xn (that is, does not provide the driving signal).

Further, within a second operation time in the second time period, the driving circuit 121 switches to transmitting the driving signal to a second one among driving electrode X2 (hereinafter referred to as a second driving electrode X2), and the detecting circuit 122 measures, by using the first sensing electrode Y1, a capacitance value of the second driving electrode X2 and corresponding to the first sensing electrode Y1. Herein, after the driving signal starts to be provided for the second driving electrode X2, the detecting circuit 122 waits for a period of stability time, and then performs measurement. In the second time period, the first operation time and the second operation time do not overlap. In some embodiments, during driving of the second driving electrode X2, the driving circuit 121 does not drive other driving electrodes X1 and X3 to Xn (that is, does not provide the driving signal).

Still further, within a third operation time in the second time period, the driving circuit 121 transmits the driving signal to a third one among driving electrode X3 (hereinafter referred to as a third driving electrode X3), and the detecting circuit 122 measures, by using the first sensing electrode Y1, a capacitance value of the third driving electrode X3 and corresponding to the first sensing electrode Y1. Herein, after the driving signal starts to be provided for the third driving electrode X3, the detecting circuit 122 waits for a period of stability time, and then performs measurement. In the second time period, the first operation time, the second operation time, and the third operation time do not overlap. In some embodiments, during driving of the third driving electrode X3, the driving circuit 121 does not drive other driving electrodes X1, X2, and X4 to Xn (that is, does not provide the driving signal).

The rest can be deduced by analogy, until all the driving electrodes X1 to Xn are driven and the capacitance value corresponding to the first sensing electrode Y1 is measured. In other words, the second time period includes a plurality of non-overlapping operation time. In the second time period, the driving circuit 121 provides the driving signal for each of the driving electrodes X1 to Xn within a different operation time, and the detecting circuit 122 separately measures, within the different operation time by using the first sensing electrode Y1, the capacitance value of one of the driving electrodes X1 to Xn and corresponding to the first sensing electrode Y1.

When the second time period ends, the detecting circuit 122 has separately measured, by using the first sensing electrode Y1, the capacitance value of one of the driving electrodes X1 to Xn and corresponding to the first sensing electrode Y1, and outputs the measured capacitance value to the control unit 123. Subsequently, the detecting circuit 122 electrically connects the first sensing electrode Y1 to a ground voltage, so that the first sensing electrode Y1 discharges.

Then, in the third time period, the voltage source 18 provides the direct current voltage Vr for a second one among sensing electrode Y2 (hereinafter referred to as a second sensing electrode Y2) through the multiplexing circuit 16, so as to use the direct current voltage Vr to precharge the second sensing electrode Y2 to a stable state. In this case, other sensing electrodes Y1, and Y3 to Ym are in the floating state.

Then, in the fourth time period, the detecting circuit 122 continues to charge the second sensing electrode Y2 by using the stability voltage, and maintains a voltage of the second sensing electrode Y2 at the stability voltage. In this case, other sensing electrodes Y1, and Y3 to Ym are in the floating state. Herein, the fourth time period is after the third time period.

In a fifth time period, the control unit 123 performs a scanning operation (hereinafter referred to as a second scanning operation) based on the second sensing electrode Y2 with the stability voltage. Herein, the fifth time period is after the fourth time period. In an example, the fifth time period is subsequent to the fourth time period.

Still further, during performing of the second scanning operation in the second time period, that is, within a first operation time in the fifth time period, the driving circuit 121 transmits the driving signal to the first one among driving electrode X1 (hereinafter referred to as the first driving electrode X1), and the detecting circuit 122 reads, by using the second sensing electrode Y2, the capacitance value of the first driving electrode X1 and corresponding to the second sensing electrode Y2. Herein, after the driving signal starts to be provided for the first driving electrode X1, the detecting circuit 122 waits for a period of stability time, and then performs measurement. In some embodiments, during driving of the first driving electrode X1, the driving circuit 121 does not drive other driving electrodes X2 to Xn (that is, does not provide the driving signal).

Further, within a second operation time in the fifth time period, the driving circuit 121 switches to transmitting the driving signal to the second one among driving electrode X2 (hereinafter referred to as the second driving electrode X2), and the detecting circuit 122 measures, by using the second sensing electrode Y2, a capacitance value of the second driving electrode X2 and corresponding to the second sensing electrode Y2. Herein, after the driving signal starts to be provided for the second driving electrode X2, the detecting circuit 122 waits for a period of stability time, and then performs measurement. In the fifth time period, the first operation time and the second operation time do not overlap. In some embodiments, during driving of the second driving electrode X2, the driving circuit 121 does not drive other driving electrodes X1 and X3 to Xn (that is, does not provide the driving signal).

Still further, within a third operation time in the fifth time period, the driving circuit 121 transmits the driving signal to the third one among driving electrode X3 (hereinafter referred to as the third driving electrode X3), and the detecting circuit 122 measures, by using the second sensing electrode Y2, a capacitance value of the third driving electrode X3 and corresponding to the second sensing electrode Y2. Herein, after the driving signal starts to be provided for the third driving electrode X3, the detecting circuit 122 waits for a period of stability time, and then performs measurement. In the fifth time period, the first operation time, the second operation time, and the third operation time do not overlap. In some embodiments, during driving of the third driving electrode X3, the driving circuit 121 does not drive other driving electrodes X1, X2, and X4 to Xn (that is, does not provide the driving signal).

The rest can be deduced by analogy, until all the driving electrodes X1 to Xn are driven and the capacitance value corresponding to the second sensing electrode Y2 is measured. In other words, the fifth time period includes a plurality of non-overlapping operation time. In the fifth time period, the driving circuit 121 provides the driving signal for each of the driving electrodes X1 to Xn within a different operation time, and the detecting circuit 122 separately measures, within the different operation time by using the second sensing electrode Y2, the capacitance value of one of the driving electrodes X1 to Xn and corresponding to the second sensing electrode Y2.

When the fifth time period ends, the detecting circuit 122 has separately measured, by using the second sensing electrode Y2, the capacitance value of one of the driving electrodes X1 to Xn and corresponding to the second sensing electrode Y2, and outputs the measured capacitance value to the control unit 123. Subsequently, the detecting circuit 122 electrically connects the second sensing electrode Y2 to the ground voltage, so that the second sensing electrode Y2 discharges.

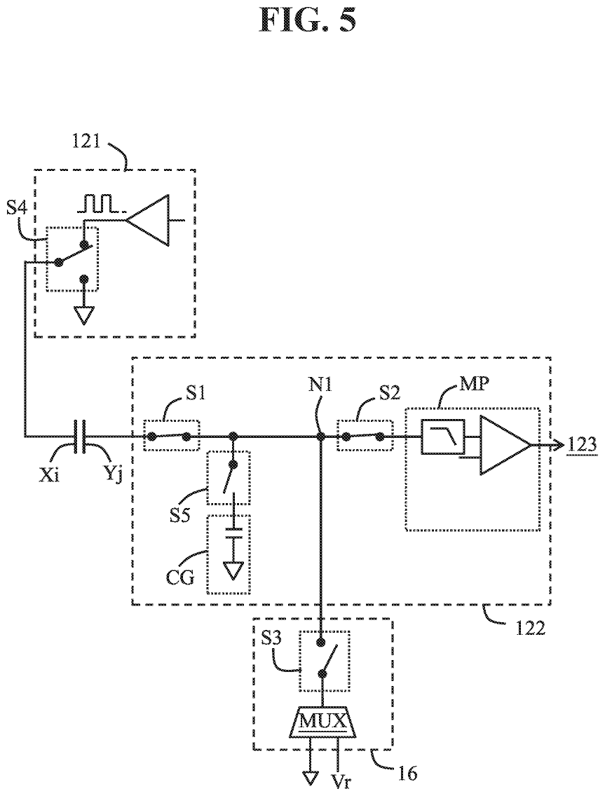

In some embodiments, referring to FIG. 5, the detecting circuit 122 includes a charging/discharging unit CG and a measurement circuit MP. The measurement circuit MP may be coupled to the sensing electrode Yj by using the switches S1 and S2. The charging/discharging unit CG may be coupled to the sensing electrode Yj by using the switches S1 and S3. In an example, the charging/discharging unit CG may be an energy storage capacitor.

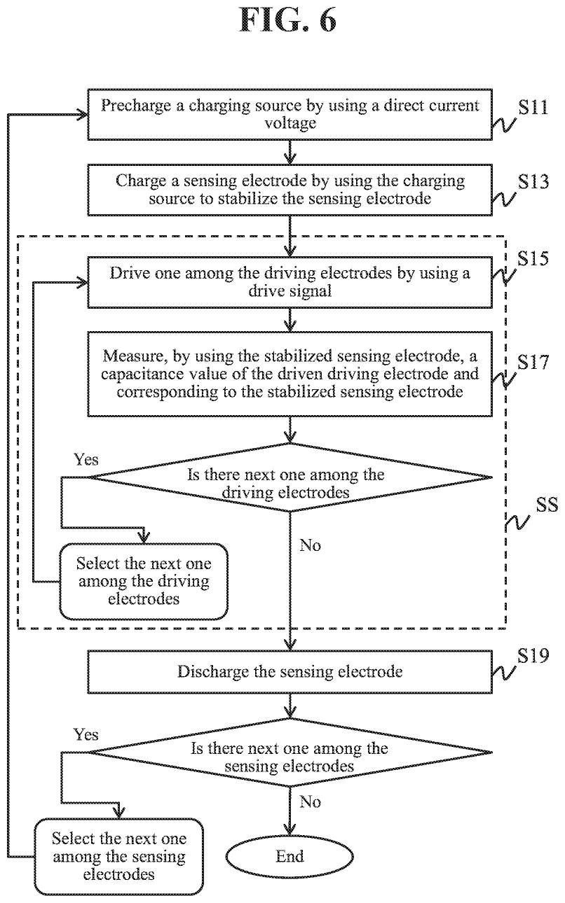

Referring to FIG. 1, FIG. 2, FIG. 5, and FIG. 6, in some embodiments, during touch sensing, the charging/discharging unit CG is first precharged. Herein, the control unit 123 controls the multiplexing circuit 16, so that the multiplexing circuit 16 electrically connects the voltage source 18 and the charging/discharging unit CG. In this case, the direct current voltage Vr is provided for the charging/discharging unit CG, to precharge the charging/discharging unit CG (step S21). During the precharging of the charging/discharging unit CG, the switch S1 and the switch S2 are both off, so that the charging/discharging unit CG electrically isolates the measurement circuit MP from the sensing electrode Yj. Other sensing electrodes Y1 to Yj−1, and Yj+1 to Ym are floating (switch to the floating state). In some embodiments, before the precharging, the multiplexing circuit 16 first electrically connects the sensing electrode Yj to the ground for discharging. After the discharging, the multiplexing circuit 16 then electrically connects the charging/discharging unit CG to the voltage source 18.

For example, in an example of step S21, during touch sensing of sensing points P(j, 1) to P(j, m) on the sensing electrode Yj, the switch S1 in the detecting circuit 122 and coupled to the sensing electrode Yj enables the sensing electrode Yj and the junction N1, and the switch S2 and a switch S5 in the detecting circuit 122 are off. The switch S3 in the multiplexing circuit 16 and corresponding to the sensing electrode Yj enables the junction N1 and the output terminal of the multiplexer MUX, and the multiplexer MUX enables the output terminal of the multiplexer MUX and is grounded, so that the sensing electrode Yj discharges to the ground. Then the switches S2 remains off, the switch S1 switches to off, the switch S5 switches to on, and the multiplexer MUX switches to enabling the output terminal of the multiplexer MUX and the direct current voltage Vr, so that the direct current voltage Vr precharges the charging/discharging unit CG.

After the precharging completes (for example, an electrical potential of the sensing electrode Yj reaches the direct current voltage), the control unit 123 controls the multiplexing circuit 16, to disable the voltage source 18, and is disconnected from the ground. Then, the control unit 123 provides a stability voltage (that is, the charging/discharging unit CG outputs the stored direct current voltage) for the precharged sensing electrode Yj by using the charging/discharging unit CG, to stabilize the sensing electrode Yj (step S23). When the electrical potential of this sensing electrode Yj is stable (remains at the stability voltage), this sensing electrode Yj is stabilized.

For example, in an example of step S23, the switch S3 in the multiplexing circuit 16 is off, and the switch S1 and the switch S5 in the detecting circuit 122 that are coupled to the sensing electrode Yj are on, so that the sensing electrode Yj enables the charging/discharging unit CG. In this case, the charging/discharging unit CG starts to charge the sensing electrode Yj, until a signal is stably indicated. This indicates that the stabilization is complete. During the stabilization of the sensing electrode Yj, the switch S1 in the detecting circuit 122 and coupled to other sensing electrodes Y1 to Yj−1, and Yj+1 to Ym is off, so that the other sensing electrodes Y1 to Yj−1, and Yj+1 to Ym are in the floating state.

Subsequently, the control unit 123 performs a scanning operation SS by using the stabilized sensing electrode Yj. In other words, after this sensing electrode Yj is stabilized, the control unit 123 controls the driving circuit 121 to drive the first one among driving electrode X1 by using the driving signal (step S25), and after this driving electrode X1 is driven and stabilized, controls the detecting circuit 122 to measure, by using the stabilized sensing electrode Yj, the capacitance value of the induced capacitance (that is, the sensing point P(1, j)) generated by the driven driving electrode X1 and the stabilized sensing electrode Yj (step S27). After measuring the capacitance value of the sensing point P(1, j), the control unit 123 controls the driving circuit 121 to drive a next one among driving electrode X2 by using the driving signal (step S25). After this driving electrode X2 is driven and stabilized, the control unit 123 controls the detecting circuit 122 to measure the stabilized sensing electrode Yj, that is, measure, by using the stabilized sensing electrode Yj, the capacitance value of the induced capacitance (that is, the sensing point P(2, j)) generated by the driven driving electrode X2 and the stabilized sensing electrode Yj (step S27). The rest can be deduced by analogy, until all the driving electrodes X1 to Xn are driven and the capacitance values of all driving electrodes and corresponding to the sensing electrode Yj are measured. In this case, the control unit 123 can obtain the capacitance values of the n sensing points P(1, j) to P(n, j).

Then, the control unit 123 controls the detecting circuit 122 to cause the measured sensing electrode Yj to discharge (step S29).

After the sensing electrode Yj discharges, touch sensing is further performed on the sensing points P(j+1, 1) to P(j+1, m) on the sensing electrode Yj+1. That is, steps S21 to S29 are repeatedly performed by using the sensing electrode Yj+1, to obtain the capacitance values of the induced capacitance generated by all driving electrodes and the sensing electrode Yj+1, that is, obtain the capacitance values of the n sensing points P(1, j+1) to P(n, j+1).

In this way, stabilization (including precharging) of the sensing electrode and the scanning operation SS based on the stabilized sensing electrode are repeatedly performed, until all the sensing electrodes are stabilized and measured, so as to obtain the capacitance values (an array signal) of all the sensing points P(1, 1) to P(n, m).

For example, under control of the control unit 123, in the first time period, the voltage source 18 provides the direct current voltage Vr for the charging/discharging unit CG by using the multiplexing circuit 16, to precharge the charging/discharging unit CG. After the precharging, the charging/discharging unit CG of the detecting circuit 122 outputs the stability voltage to charge the first sensing electrode Y1 (hereinafter referred to as the first sensing electrode Y1), and maintains a voltage of the first sensing electrode Y1 at the stability voltage. In this case, other sensing electrodes Y2 to Ym are in the floating state.

In the second time period, the control unit 123 performs a scanning operation (hereinafter referred to as the first scanning operation) based on the first sensing electrode Y1 with the stability voltage. In this case, the other sensing electrodes Y2 to Ym are in the floating state. Herein, the second time period is after the first time period. In an example, the second time period is subsequent to the first time period.

Still further, during performing of the first scanning operation in the second time period, that is, within the first operation time in the second time period, the driving circuit 121 transmits the driving signal to the first one among driving electrode X1 (hereinafter referred to as the first driving electrode X1), and the detecting circuit 122 reads, by using the first sensing electrode Y1, the capacitance value of the first driving electrode X1 and corresponding to the first sensing electrode Y1. Herein, after the driving signal starts to be provided for the first driving electrode X1, the detecting circuit 122 waits for a period of stability time, and then performs measurement. In some embodiments, during driving of the first driving electrode X1, the driving circuit 121 does not drive other driving electrodes X2 to Xn (that is, does not provide the driving signal).

Further, within the second operation time in the second time period, the driving circuit 121 switches to transmitting the driving signal to the second one among driving electrode X2 (hereinafter referred to as the second driving electrode X2), and the detecting circuit 122 measures, by using the first sensing electrode Y1, the capacitance value of the second driving electrode X2 and corresponding to the first sensing electrode Y1. Herein, after the driving signal starts to be provided for the second driving electrode X2, the detecting circuit 122 waits for a period of stability time, and then performs measurement. In the second time period, the first operation time and the second operation time do not overlap. In some embodiments, during driving of the second driving electrode X2, the driving circuit 121 does not drive other driving electrodes X1 and X3 to Xn (that is, does not provide the driving signal).

Still further, within the third operation time in the second time period, the driving circuit 121 transmits the driving signal to the third one among driving electrode X3 (hereinafter referred to as the third driving electrode X3), and the detecting circuit 122 measures, by using the first sensing electrode Y1, the capacitance value of the third driving electrode X3 and corresponding to the first sensing electrode Y1. Herein, after the driving signal starts to be provided for the third driving electrode X3, the detecting circuit 122 waits for a period of stability time, and then performs measurement. In the second time period, the first operation time, the second operation time, and the third operation time do not overlap. In some embodiments, during driving of the third driving electrode X3, the driving circuit 121 does not drive other driving electrodes X1, X2, and X4 to Xn (that is, does not provide the driving signal).

The rest can be deduced by analogy, until all the driving electrodes X1 to Xn are driven and the capacitance value corresponding to the first sensing electrode Y1 is measured. In other words, the second time period includes a plurality of non-overlapping operation time. In the second time period, the driving circuit 121 provides the driving signal for each of the driving electrodes X1 to Xn within a different operation time, and the detecting circuit 122 separately measures, within the different operation time by using the first sensing electrode Y1, the capacitance value of one of the driving electrodes X1 to Xn and corresponding to the first sensing electrode Y1.

When the second time period ends, the detecting circuit 122 has separately measured, by using the first sensing electrode Y1, the capacitance value of one of the driving electrodes X1 to Xn and corresponding to the first sensing electrode Y1, and outputs the measured capacitance value to the control unit 123. Subsequently, the detecting circuit 122 electrically connects the first sensing electrode Y1 to a ground voltage, so that the first sensing electrode Y1 discharges.

Then, in the third time period, the voltage source 18 provides the direct current voltage Vr for the charging/discharging unit CG by using the multiplexing circuit 16, to precharge the charging/discharging unit CG. After the precharging, the charging/discharging unit CG of the detecting circuit 122 outputs the stability voltage to charge the second one among sensing electrode Y2 (hereinafter referred to as the second sensing electrode Y2), and maintains the voltage of the second sensing electrode Y2 at the stability voltage. In this case, other sensing electrodes Y1, and Y3 to Ym are in the floating state. Herein, the third time period is after the second time period. In an example, the third time period is subsequent to the second time period.

In the fourth time period, the control unit 123 performs a scanning operation (hereinafter referred to as the second scanning operation) based on the second sensing electrode Y2 with the stability voltage. In this case, other sensing electrodes Y1, and Y3 to Ym are in the floating state. Herein, the fourth time period is after the third time period, and the fifth time period is after the fourth time period. In an example, the fifth time period is subsequent to the fourth time period.

Still further, during performing of the first scanning operation in the fourth time period, that is, within the first operation time in the fourth time period, the driving circuit 121 transmits the driving signal to the first one among driving electrode X1 (hereinafter referred to as the first driving electrode X1), and the detecting circuit 122 reads, by using the second sensing electrode Y2, the capacitance value of the first driving electrode X1 and corresponding to the second sensing electrode Y2. Herein, after the driving signal starts to be provided for the first driving electrode X1, the detecting circuit 122 waits for a period of stability time, and then performs measurement. In some embodiments, during driving of the first driving electrode X1, the driving circuit 121 does not drive other driving electrodes X2 to Xn (that is, does not provide the driving signal).

Further, within the second operation time in the fourth time period, the driving circuit 121 switches to transmitting the driving signal to the second one among driving electrode X2 (hereinafter referred to as the second driving electrode X2), and the detecting circuit 122 measures, by using the second sensing electrode Y2, the capacitance value of the second driving electrode X2 and corresponding to the second sensing electrode Y2. Herein, after the driving signal starts to be provided for the second driving electrode X2, the detecting circuit 122 waits for a period of stability time, and then performs measurement. In the fourth time period, the first operation time and the second operation time do not overlap. In some embodiments, during driving of the second driving electrode X2, the driving circuit 121 does not drive other driving electrodes X1 and X3 to Xn (that is, does not provide the driving signal).

Still further, within a third operation time in the fourth time period, the driving circuit 121 transmits the driving signal to the third one among driving electrode X3 (hereinafter referred to as the third driving electrode X3), and the detecting circuit 122 measures, by using the second sensing electrode Y2, the capacitance value of the third driving electrode X3 and corresponding to the second sensing electrode Y2. Herein, after the driving signal starts to be provided for the third driving electrode X3, the detecting circuit 122 waits for a period of stability time, and then performs measurement. In the fourth time period, the first operation time, the second operation time, and the third operation time do not overlap. In some embodiments, during driving of the third driving electrode X3, the driving circuit 121 does not drive other driving electrodes X1, X2, and X4 to Xn (that is, does not provide the driving signal).

The rest can be deduced by analogy, until all the driving electrodes X1 to Xn are driven and the capacitance value corresponding to the second sensing electrode Y2 is measured. In other words, the third time period includes a plurality of non-overlapping operation time. In the third time period, the driving circuit 121 provides the driving signal for each of the driving electrodes X1 to Xn within a different operation time, and the detecting circuit 122 separately measures, within the different operation time by using the second sensing electrode Y2, the capacitance value of one of the driving electrodes X1 to Xn and corresponding to the second sensing electrode Y2.

When the fourth time period, the detecting circuit 122 has separately measured, by using the second sensing electrode Y2, the capacitance value of one of the driving electrodes X1 to Xn and corresponding to the second sensing electrode Y2, and outputs the measured capacitance value to the control unit 123. Subsequently,the detecting circuit 122 electrically connects the second sensing electrode Y2 to the ground voltage, so that the second sensing electrode Y2 discharges.

The capacitance value may correspond to the touch sensing signal read by the signal processing circuit 12.

In some embodiments, the signal processing circuit 12 may be implemented by a single chip or multiple chips. Moreover, a storage unit may be built in and/or externally connected to the control unit 123, to store related a software/firmware program, information, data, a combination thereof, and the like. In addition, the storage unit may be implemented by one or more memories.

In conclusion, according to the touch sensing device and the method for sensing a touch sensing signal of the embodiments of the present invention, after a settling process of any sensing electrode, the same stabilized sensing electrode is read in an order in which all driving electrodes are selected, and another sensing electrode does not need to be stabilized unless a sensing electrode other than the sensing electrode that is currently used needs to be used, to reduce a settling time. In addition, the any sensing electrode first undergoes a direct current precharging process, and then is stabilized by using a stability voltage until a level is table, to further reduce the settling time. Therefore, according to the touch sensing device and the method for sensing a touch sensing signal of the embodiments of the present invention, an entire driving and reading period can be shortened, to effectively increase a frame rate and further improve touch control effectiveness and performance of the touch sensing device.

What is claimed is:

1. A method for sensing a touch sensing signal, comprising:
providing a direct current voltage for a first sensing electrode in a first time period, to stabilize the first sensing electrode;
performing a first scanning operation by using the stabilized first sensing electrode in a second time period, wherein the second time period is after the first time period, and the execution step of the first scanning operation comprises:
driving a first driving electrode by using a driving signal within a first operation time in the second time period, and measuring, based on the stabilized first sensing electrode, a capacitance value of the driven first driving electrode and corresponding to the first sensing electrode; and
driving a second driving electrode by using the driving signal within a second operation time in the second time period, and measuring, based on the stabilized first sensing electrode, a capacitance value of the driven second driving electrode and corresponding to the first sensing electrode; and
providing the direct current voltage for a second sensing electrode in a third time period, to stabilize the second sensing electrode, wherein the third time period is after the second time period.

2. The method for sensing a touch sensing signal according to claim 1, further comprising: performing a second scanning operation by using the stabilized second sensing electrode in a fourth time period, wherein the fifth time period is after the fourth time period, and the execution step of the second scanning operation comprises:
driving the first driving electrode by using the driving signal within a first operation time in the fourth time period, and measuring, based on the stabilized second sensing electrode, a capacitance value of the driven first driving electrode and corresponding to the second sensing electrode; and
driving the second driving electrode by using the driving signal within a second operation time in the fourth time period, and measuring, based on the second sensing electrode, a capacitance value of the driven second driving electrode and corresponding to the second sensing electrode.

3. The method for sensing a touch sensing signal according to claim 1, wherein the direct current voltage is a median of the driving signal.

4. The method for sensing a touch sensing signal according to claim 1, wherein the driving signal is a periodical wave.

5. A method for sensing a touch sensing signal, comprising:
precharging a charging/discharging unit by using a direct current voltage in a first time period, and charging a first sensing electrode by using the charging/discharging unit, to stabilize the first sensing electrode;
performing a first scanning operation by using the stabilized first sensing electrode in a second time period, wherein the second time period is after the first time period, and the execution step of the first scanning operation comprises:
driving a first driving electrode by using a driving signal within a first operation time in the second time period, and measuring, based on the stabilized first sensing electrode, a capacitance value of the driven first driving electrode and corresponding to the first sensing electrode; and
driving a second driving electrode by using the driving signal within a second operation time in the second time period, and measuring, based on the stabilized first sensing electrode, a capacitance value of the driven second driving electrode and corresponding to the first sensing electrode; and
precharging a charging/discharging unit by using the direct current voltage in a third time period, and charging a second sensing electrode by using the charging/discharging unit, to stabilize the second sensing electrode, wherein the third time period is after the second time period.

6. The method for sensing a touch sensing signal according to claim 5, further comprising: performing a second scanning operation by using the stabilized second sensing electrode in a fourth time period, wherein the fifth time period is after the fourth time period, and the execution step of the second scanning operation comprises:
driving the first driving electrode by using the driving signal within a first operation time in the fourth time period, and measuring, based on the stabilized second sensing electrode, a capacitance value of the driven first driving electrode and corresponding to the second sensing electrode; and
driving the second driving electrode by using the driving signal within a second operation time in the fourth time period, and measuring, based on the second sensing electrode, a capacitance value of the driven second driving electrode and corresponding to the second sensing electrode.

7. The method for sensing a touch sensing signal according to claim 5, wherein the direct current voltage is a median of the driving signal.

8. The method for sensing a touch sensing signal according to claim 5, wherein the driving signal is a periodical wave.

9. A touch sensing device, comprising:
a first sensing electrode;
a second sensing electrode;
a first driving electrode;
a second driving electrode;
a voltage source, providing a direct current voltage;
a multiplexing circuit, coupled to the first sensing electrode, the second sensing electrode, and the voltage source; and
a signal processing circuit, coupled to the first sensing electrode, the second sensing electrode, the first driving electrode, the second driving electrode, and the multiplexing circuit, wherein the signal processing circuit is configured to perform the following steps:
controlling, in a first time period, the multiplexing circuit to electrically connect to the voltage source and the first sensing electrode, so that the direct current voltage charges the first sensing electrode to stabilize the first sensing electrode;
performing a first scanning operation by using the stabilized first sensing electrode in a second time period, wherein the second time period is after the first time period, and the execution step of the first scanning operation comprises:
driving a first driving electrode by using a driving signal within a first operation time in the second time period, and measuring, based on the stabilized first sensing electrode, a capacitance value of the driven first driving electrode and corresponding to the first sensing electrode; and
driving a second driving electrode by using the driving signal within a second operation time in the second time period, and measuring, based on the stabilized first sensing electrode, a capacitance value of the driven second driving electrode and corresponding to the first sensing electrode; and
controlling, in a third time period, the multiplexing circuit to electrically connect to the voltage source and the second sensing electrode, so that the direct current voltage charges the second sensing electrode to stabilize the first sensing electrode, wherein the third time period is after the second time period.

10. The touch sensing device according to claim 9, wherein the signal processing circuit is further configured to perform the following step: performing a second scanning operation by using the stabilized second sensing electrode in a fourth time period, wherein the fourth time period is after the third time period, and the execution step of the second scanning operation comprises:
driving the first driving electrode by using the driving signal within a first operation time in the fourth time period, and measuring, based on the stabilized second sensing electrode, a capacitance value of the driven first driving electrode and corresponding to the second sensing electrode; and
driving the second driving electrode by using the driving signal within a second operation time in the fourth time period, and measuring, based on the second sensing electrode, a capacitance value of the driven second driving electrode and corresponding to the second sensing electrode.

11. The touch sensing device according to claim 9, wherein the direct current voltage is a median of the driving signal.

12. The touch sensing device according to claim 9, wherein the driving signal is a periodical wave.

13. A touch sensing device, comprising:
a first sensing electrode;
a second sensing electrode;
a first driving electrode;
a second driving electrode;
a voltage source, providing a direct current voltage;
a multiplexing circuit, coupled to the first sensing electrode, the second sensing electrode, and the voltage source; and
a signal processing circuit, coupled to the first sensing electrode, the second sensing electrode, the first driving electrode, the second driving electrode, and the multiplexing circuit, wherein the signal processing circuit is configured to perform the following steps:
controlling, in a first time period, the multiplexing circuit to turn on the voltage source to precharge a charging/discharging unit by using the direct current voltage, then controlling the multiplexing circuit to turn off the voltage source, and charging the first sensing electrode by using the voltage source after the precharging, to stabilize the first sensing electrode;
performing a first scanning operation by using the stabilized first sensing electrode in a second time period, wherein the second time period is after the first time period, and the execution step of the first scanning operation comprises:
driving a first driving electrode by using a driving signal within a first operation time in the second time period, and measuring, based on the stabilized first sensing electrode, a capacitance value of the driven first driving electrode and corresponding to the first sensing electrode; and
driving a second driving electrode by using the driving signal within a second operation time in the second time period, and measuring, based on the stabilized first sensing electrode, a capacitance value of the driven second driving electrode and corresponding to the first sensing electrode; and
controlling, in a third time period, the multiplexing circuit to turn on the voltage source to precharge the charging/discharging unit by using the direct current voltage, then controlling the multiplexing circuit to turn off the voltage source, and charging the second sensing electrode by using the voltage source, to stabilize the first sensing electrode, wherein the third time period is after the second time period.

14. The touch sensing device according to claim 13, wherein the signal processing circuit is further configured to perform the following step: performing a second scanning operation by using the stabilized second sensing electrode in a fourth time period, wherein the fourth time period is after the third time period, and the execution step of the second scanning operation comprises:
driving the first driving electrode by using the driving signal within a first operation time in the fourth time period, and measuring, based on the stabilized second sensing electrode, a capacitance value of the driven first driving electrode and corresponding to the second sensing electrode; and
driving the second driving electrode by using the driving signal within a second operation time in the fourth time period, and measuring, based on the second sensing electrode, a capacitance value of the driven second driving electrode and corresponding to the second sensing electrode.

15. The touch sensing device according to claim 13, wherein the direct current voltage is a median of the driving signal.

16. The touch sensing device according to claim 13, wherein the driving signal is a periodical wave.
